(19) United States
(12) Patent Application Publication
(10) Pub. No.: US 2017/0235784 A1
(43) Pub. Date: Aug. 17, 2017

(54) SYSTEM AND METHOD FOR IMPROVING PERFORMANCE OF UNSTRUCTURED TEXT EXTRACTION

(71) Applicant: KOREA INSTITUTE OF SCIENCE AND TECHNOLOGY INFORMATION, Daejeon (KR)

(72) Inventors: Choong-Nyoung SEON, Daejeon (KR); Sa-Kwang SONG, Daejeon (KR); Minhee CHO, Daejeon (KR); Sungho SHIN, Daejeon (KR); Hyung-Jun YIM, Daejeon (KR); Minsu JOH, Daejeon (KR); Won-Kyung SUNG, Daejeon (KR)

(21) Appl. No.: 15/370,222

(22) Filed: Dec. 6, 2016

(30) Foreign Application Priority Data
Feb. 17, 2016 (KR) 10-2016-0018386

(51) Int. Cl. G06F 17/30; G06N 99/00; G06F 17/27

(52) U.S. Cl. CPC G06F 17/30371; G06F 17/2765; G06F 17/30684; G06F 17/30699; G06F 17/30551; G06F 17/30241; G06F 17/30569; G06N 99/005

(57) ABSTRACT

A system and method for improving performance of unstructured text extraction. The system includes an unstructured data processing unit configured to extract time information or space information in which an event keyword and an event have been generated by performing a linguistic analysis on collected unstructured text and to generate extraction knowledge candidates by mapping the time information or space information to the event keyword and a filter unit configured to determine the validity of the extraction knowledge candidates generated by the unstructured data processing unit using spatiotemporal association structured data.

### CROSS REFERENCE TO RELATED APPLICATION

The present application claims the benefit of Korean Patent Application No. 10-2016-0018386 filed in the Korean Intellectual Property Office on Feb. 17, 2016, the entire contents of which are incorporated herein by reference.

### BACKGROUND OF THE INVENTION

1. Technical Field

The present invention relates to a system and method for improving performance of unstructured text extraction and, more particularly, to a system and method for improving performance of unstructured text extraction, which verify the results of the extraction of text information using time information or space information indicative of an actual present situation.

2. Description of Related Art

Research for extracting information from unstructured text, such as web news, and summarizing a subject or extracting a core incident or event is recently carried out. In this case, an “event” in a common meaning refers to an incident that is problematic or that may attract attention. In contrast, an “event” from an information extraction viewpoint for digital information processing is information indicative of a core incident or subject mentioned in given document and means the subject of information extraction.

Text information extraction for a natural language is a technology which is used to select required information in a document set written in a natural language and generate the selected information in the form of a structured expression. Recently, such a technology is connected to a web environment or a social network, and importance thereof is further increased.

However, although an effective text information extraction technology is present, there is still a problem in extracting a fact associated with an actual situation due to various expressions of a natural language and various metaphorical or figurative expressions used by people.

Furthermore, there is a disadvantage in that it is difficult to measure the verification or reliability of extracted results because a text information extraction technology depends on only the analysis of information included in text itself.

### SUMMARY OF THE INVENTION

An embodiment of the present invention provides a system and method for improving performance of unstructured text extraction, which verify the results of the extraction of text information using time information or space information indicative of an actual present situation.

In accordance with an aspect of the present invention, there is provided a system for improving performance of unstructured text extraction, including an unstructured data processing unit configured to extract time information or space information in which an event keyword and an event have been generated by performing a linguistic analysis on collected unstructured text and to generate extraction knowledge candidates by mapping the time information or space information to the event keyword and a filter unit configured to determine the validity of the extraction knowledge candidates generated by the unstructured data processing unit using spatiotemporal association structured data.

The system may further include a structured data processing unit configured to collect structured data and generate spatiotemporal association structured data by standardizing the collected structured data.

The structured data processing unit may include a collection module configured to collect time-series structured data and common structured data, a filter module configured to standardize the time-series structured data and the common structured data, an estimation module configured to correct errors of the standardized time-series structured data and common structured data based on actually measured values on a spatiotemporal coordinate plane, an extension module configured to extend the error-corrected time-series structured data and common structured data to data of all points on the spatiotemporal coordinates, and a storage module configured to distribute and store in parallel the data extended by the extension module.

The unstructured data processing unit may include a collection module configured to collect the unstructured text from an information source, an extraction module configured to extract the time information or space information in which the event keyword and the event have been generated by performing the linguistic analysis on the collected unstructured text, an analysis module configured to materialize the extracted time information or space information, and an association module configured to generate the extraction knowledge candidates by mapping the materialized time information or space information to the event keyword.

If the collection module has collected collection situation metadata of the unstructured text, the analysis module may include a time information analysis module configured to convert the extracted time information into absolute time information using time information included in the collection situation metadata and a space information analysis module configured to materialize the extracted space information using space information included in the collection situation metadata.

The filter unit may include a filter module configured to determine the validity of the extraction knowledge candidates using a precondition model suitable for the extraction knowledge candidates.

Furthermore, the system may further include a condition model learning module configured to determine a precondition using the spatiotemporal association structured data and past history information.

In accordance with another aspect of the present invention, there is provided a method for improving performance of unstructured text extraction, including the steps of (A) collecting unstructured text, (B) extracting time information or space information in which an event keyword and an event have been generated by performing a linguistic analysis on the collected unstructured text, (C) generating extraction knowledge candidates by mapping the time information or space information to the event keyword, and (D) determining the validity of the generated extraction knowledge candidates using spatiotemporal association structured data.

If the unstructured text and collection situation metadata of the unstructured text have been collected in the step (A), the step (C) may include converting the extracted time information into absolute time information using time information included in the collection situation metadata and materializing the extracted space information using space information included in the collection situation metadata and generating the extraction knowledge candidates by mapping the absolute time information or the materialized space information to the event keyword.

The spatiotemporal association structured data may be generated by standardizing time-series structured data and common structured data, correcting errors of the standardized time-series structured data and common structured data using actually measured values on a spatiotemporal coordinate plane, and extending the error-corrected time-series structured data and common structured data to data of all points on the spatiotemporal coordinates.

The step (D) may include selecting a precondition model for determining the validity of the extraction knowledge candidates in previously constructed precondition models and determining the validity of the extraction knowledge candidates using the selected precondition model and removing invalid extraction knowledge candidates.

The precondition model may be generated using a machine learning method using spatiotemporal association structured data and past history information.

### BRIEF DESCRIPTION OF THE DRAWINGS

FIG. 1 is a diagram showing a system for improving performance of unstructured text extraction according to an embodiment of the present invention.

FIG. 2 is a detail block diagram showing the configuration of an unstructured data processing unit shown in FIG. 1.

FIG. 3 is a detailed block diagram showing the configuration of a filter unit shown in FIG. 1.

FIG. 4 is a detailed block diagram showing the configuration of a structured data processing unit shown in FIG. 1.

FIG. 5 is a flowchart illustrating a method for improving performance of unstructured text extraction according to an embodiment of the present invention.

FIG. 6 is a flowchart illustrating a method for generating spatiotemporal association structured data according to an embodiment of the present invention.

### DETAILED DESCRIPTION

Hereinafter, a system and method for improving performance of unstructured text extraction according to embodiments of the present invention are described in detail with reference to the accompanying drawings. Embodiments to be described hereunder are provided in order for those skilled in the art to easily understand the technical spirit of the present invention, and the present invention is not restricted by the embodiments. Furthermore, contents represented in the accompanying drawings have been diagrammed to easily describe the embodiments of the present invention, and the contents may be different from actually implemented forms.

Each of elements described hereunder may be purely implemented using a hardware or software element, but may be implemented using a combination of various hardware and software elements that perform the same function. Furthermore, two or more elements may be implemented using a piece of hardware or software.

Furthermore, an expression that some elements are “included” is an expression of an “open type”, and the expression simply denotes that the corresponding elements are present, but should not be construed as excluding additional elements.

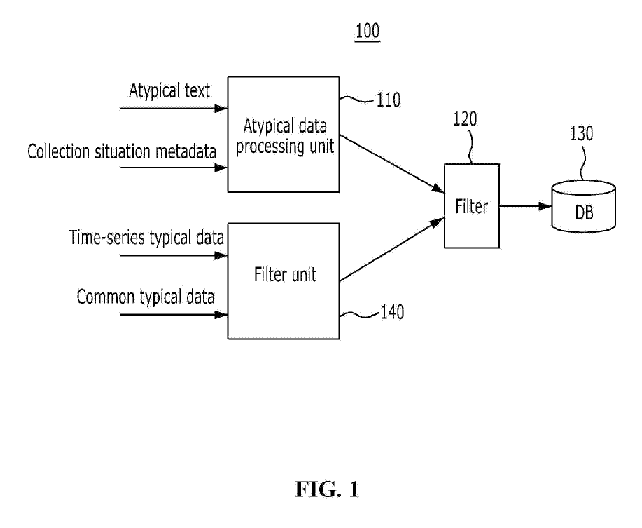

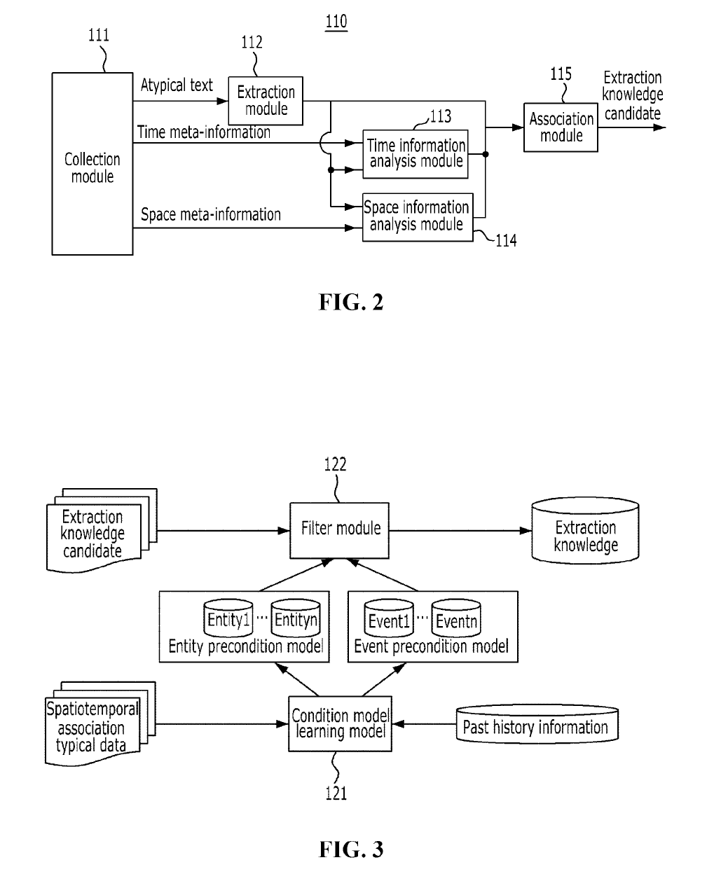

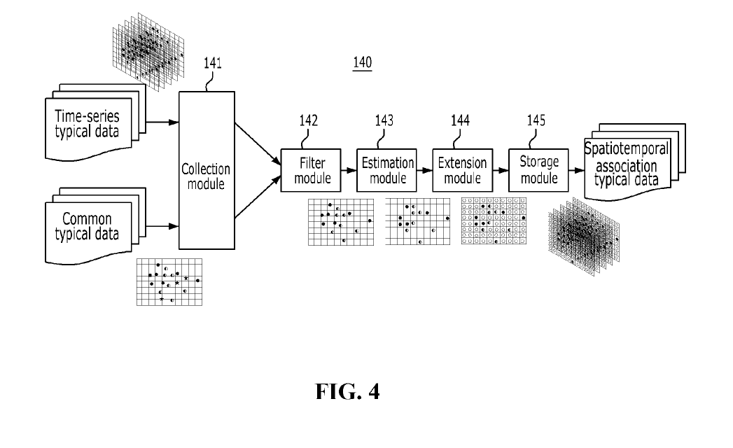

FIG. 1 is a diagram showing a system for improving performance of unstructured text extraction according to an embodiment of the present invention. FIG. 2 is a detail block diagram showing the configuration of an unstructured data processing unit shown in FIG. 1. FIG. 3 is a detailed block diagram showing the configuration of a filter unit shown in FIG. 1. FIG. 4 is a detailed block diagram showing the configuration of a structured data processing unit shown in FIG. 1.

Referring to FIG. 1, the system 100 for improving performance of unstructured text extraction includes an unstructured data processing unit 110 and a filter unit 120.

The unstructured data processing unit 110 collects unstructured data, extracts time information or space information in which an event occurred by performing a linguistic analysis of the collected unstructured data, and generates extraction knowledge candidates by mapping the time information or space information to an event keyword. In this case, the unstructured data processing unit 110 may collect the unstructured data and the collection situation metadata of the unstructured data. In this case, the unstructured data processing unit 110 may materialize the extracted time information or space information by taking into consideration the collection situation metadata from which the unstructured data has been collected and generate the extraction knowledge candidates by mapping the materialized time information or space information to the event keyword.

FIG. 2 is a detail block diagram showing the configuration of the unstructured data processing unit 110 shown in FIG. 1. The unstructured data processing unit 110 includes a collection module 111, an extraction module 112, a time information analysis module 113, a space information analysis module 114, and an association module 115.

The collection module 111 collects unstructured text or unstructured data and the collection situation metadata of the unstructured data.

That is, the collection module 111 collects document data of a text form as unstructured text from various information sources. In this case, the collection module 111 may collect unstructured text from various information sources (e.g., news, blogs, and social web media including social networking service (SNS), such as Twitter and Facebook).

Furthermore, the collection module 111 collects collection situation metadata including information about time and a location in which unstructured text has been posted on an information source.

The extraction module 112 performs a linguistic analysis of the unstructured text collected by the collection module 111 and extracts an event keyword and time information or space information in which an event occurred.

The extraction module 112 performs a linguistic analysis of document data by performing at least one of a morphology analysis and named entity recognition (NER). In this case, the extraction module 112 may perform preprocessing, such as misprint, a spacing error, and synonym processing, prior to the morphology analysis and the NER.

Thereafter, the extraction module 112 extracts an event keyword from the linguistically analyzed document data. The event keyword may be a noun, and the extraction module 112 may extract the event keyword from a sentence using the results of the execution of the morphology analysis and the NER. In this case, the event keyword may be a natural disaster (e.g., an earthquake or a forest fire), a disease (e.g., a foot-and-mouse disease or a swine flu), an incident/accident (e.g., a plane crash accident). Furthermore, the event keyword may be a case where what incident or accident has occurred in the main agent (or subject) or object of an event in document data and a sentence.

After the event keyword is extracted, the extraction module 112 extracts event time information from the event sentence. For example, the extraction module 112 may recognize vocabularies indicative of dates in the linguistically analyzed document data and extract event time information. More specifically, the extraction module 112 may recognize vocabularies (e.g., 00, 0, 0, three days from now, and two days after tomorrow) on which time entity names, such as <DT_DAY>, <DT_OTHERS>, and <TI_DURATION>, have been tagged in the linguistically analyzed sentence, that is, vocabularies that represent a date and/or a period, such as a year, a month, a day, an hour, and a period, and extract the event time information. To this end, the vocabulary information (or tagging information) that represents a date and time may have been previously stored. When the event time information is extracted from the event sentence, the extraction module 112 may normalize the extracted event time information. For example, the extraction module 112 may normalize Nov. 30, 2010, that is, extracted event time information, in a form, such as 2010-11-30. In this case, the normalization form may have been previously set and may have been previously set in one of various forms, such as YYYY-MM-DD, YY-MM-DD, and MM-DD-YY.

Furthermore, when the event keyword is extracted, the extraction module 112 extracts event location information from the event sentence. More specifically, the extraction module 112 may recognize vocabularies indicative of areas in the linguistically analyzed document data and extract event location information. For example, the extraction module 112 may recognize vocabularies including area names, such as “province, city/county, dong/myeon/eup, and ri”, with respect to entity name vocabularies related to places, such as <LCP_PROVINCE>, <LCP_CITY>, and <LCP_COUNTY>, in the linguistically analyzed event sentence and extract the event location information. To this end, information indicative of an area and location (i.e., area vocabulary information) may have been previously stored. When the event location information is extracted from the event sentence, the extraction module 112 may normalize the extracted event location information. For example, the extraction module 112 may normalize Seoul/Gangnam-gu/Daechi-dong, that is, extracted event location information, in at least one form of area code and GPS coordinates. In this case, the area code is a combination of numbers assigned depending on the classification of province/city/county, and the GPS coordinates are absolute coordinates of an X, Y form. Information about the area code and the GPS coordinates may have been previously stored and may be used when event location information is normalized.

The time information analysis module 113 converts the time information, extracted by the extraction module 112, into absolute time information using the time information included in the collection situation metadata collected by the collection module 111. That is, time may be unclear based on only event time information extracted by the extraction module 112. In order to solve such a problem, the time information analysis module 113 converts time information in which an event was generated into absolute time information using time meta-information on which corresponding document data has been posted. For example, a vocabulary indicative of a date in an event sentence is the 30^{th}, but it is unclear that it is the 30^{th} of what month of what year. In this case, the time information analysis module 113 may analogize the 30^{th} in the event sentence as “Jan. 30, 2016” by taking into consideration “Jan. 5, 2016”, that is, date information (i.e., an article report) in which document data included in the event sentence was posted on media and converts the event time information into the absolute time information.

The space information analysis module 114 materializes the location information extracted by the extraction module 112 using space meta-information included in the collection situation metadata. That is, the place where the event occurred may be unclear based on only the location information extracted by the extraction module 112. In order to solve such a problem, the space information analysis module 114 may materialize the location information in which the event was generated using the space meta-information on which the corresponding document data was posted.

The association module 115 generates extraction knowledge candidates by mapping the absolute time information obtained by the time information analysis module 113 or the location information materialized by the space information analysis module 114 to the event keyword extracted by the extraction module 112.

The filter unit 120 determines the validity of the extraction knowledge candidates generated by the unstructured data processing unit 110 using spatiotemporal association structured data, filters the extraction knowledge based on a result of the determination, and stores the filtered extraction knowledge in a database (DB) 130. That is, the filter unit 120 detects the validity of the extraction knowledge candidates extracted from the unstructured data using the spatiotemporal association structured data and removes an invalid extraction knowledge candidate.

FIG. 3 is a detailed block diagram showing the configuration of the filter unit 120 shown in FIG. 1. The filter unit 120 may include a filter module 122 for determining the validity of the extraction knowledge candidates using a precondition model suitable for the extraction knowledge candidates generated by the unstructured data processing unit 110. In this case, the precondition model may be a model learnt based on the spatiotemporal association structured data and past history information in order to verify the validity of the extraction knowledge candidates.

To this end, the filter unit 120 may further include a condition model learning module 121 for learning the precondition model.

The condition model learning module 121 learns the precondition model using the spatiotemporal association structured data and the past history information. In this case, the condition model learning module 121 may learn the precondition model using an expert's knowledge or may learn the precondition model using a machine learning method based on the past history information.

A method for learning the precondition model is described below by taking an example “since an area A has a low ground, a river overflows although it rains only 50 mm and thus a flood is generated in the area A” and an example “an area B has no flood no matter how hard it rains because the area B is a mountain area and has no source of water supply.”

First, an example in which an expert's knowledge is used is described.

In this case, the condition model learning module 121 generates the expert's knowledge as a rule without any change. That is, if geographical information and rainfall information are used in structured data, “an area A may have a flood when it rains 50 mm or more” may be set as a precondition.

An example in which a machine learning method using past history information is used is described below.

In this case, the condition model learning module 121 learns spatiotemporal association structured data and past history information for each area using machine learning and determines a precondition using the results of the learning. “An altitude of 50 m, within an average distance of 1 km from a reservoir, and a distance of about 300 m from a river of 10 m or more in width” have been set as the characteristic information of the area A. “An altitude of 800 m, no source of water supply within nearby 10 km, and no river of 5 m or more in width” have been set as the characteristic information of the area B. Past history information of the area A describes that “a flood from the second day when it rains for three days with the amount of rainfall of 50-100 mm and a flood when it rains for 1 hour with the amount of rainfall of 150 mm.”

In this case, the condition model learning module 121 inputs time-series structured information (e.g., a change of rainfall per minute and a change of the water level of a river) and location characteristic information (e.g., the distance from a river of 5 m or more in width for each location and the distance from a reservoir having the amount of water of 1 t or more) as structured information and determines a precondition using a method for learning a rule, such as a decision tree.

The condition model learning module 121 may learn an entity precondition model and an event precondition model.

The entity precondition model is a model used to limit the meaning of a word itself to a specific meaning based on the type of entity, that is, an object, and a requested characteristic. The entity refers to a detailed object, such as a person, a place name, and an organization name.

For example, in the case of a sentence reading that “not only Umyeon Mountain in which a landslide was generated, but neighboring Guryongsan Mountain and Cheonggyesan Mountain need to be urgently repaired”, in conventional text processing, when “Umyeon Mountain”, “Guryongsan Mountain”, and “Cheonggyesan Mountain” are extracted, such an extraction is ended as a right answer. If the place that needs to be urgently repaired is to be found, however, the physical locations of the places are required. For example, in Korea, the place having the name of “Umyeon Mountain” is only one, but the place having the name of “Cheonggyesan Mountain” is four and the place having the name of Guryongsan Mountain is six. In this case, three places need to be close in distance because area-related information, such as “neighboring”, is included in the sentence. If <neighboring, vicinity, etc. is within a radius of 10 km with respect to an object, such as a mountain> has been defined as a precondition according to an expert's knowledge, both Cheonggyesan Mountain and Guryongsan Mountain are determined to be mountains present near Seocho-gu, Seoul according to the precondition. As described above, the entity precondition model is a model used to limit the meaning of a word itself to a specific meaning based on the type of entity, that is, an object, and a requested characteristic.

The event precondition model is a model for checking a special event situation using pieces of related information. If a specific event, for example, a situation called a “flood” is present, a minimum condition in which a flood is generated, for example, contents, such as the amount of rainfall of 100 mm or more and the water level “xx m” of a river, are checked from structured data. Assuming that “a flood was generated at a Daejeon home”, it may estimate that the “flood” is not generated in “Daejeon”, but the “flood” is a personal event from a situation “Daejeon.” As described above, a method for checking a special event situation using pieces of related information is the event precondition model.

As described above, the filter unit 120 learns the precondition model of an entity and an event, that is, an object of extraction knowledge candidates, through a machine learning method using pieces of information monitored and summarized in the past as learning data and removes improper extraction knowledge candidates using a learnt model.

The system 100 for improving performance of unstructured text extraction may further include a structured data processing unit 140 for generating spatiotemporal association structured data.

The structured data processing unit 140 collects structured data and generates spatiotemporal association structured data by standardizing the collected structured data.

FIG. 4 is a detailed block diagram showing the configuration of the structured data processing unit 140 shown in FIG. 1. The structured data processing unit 140 includes a collection module 141, a filter module 142, an estimation module 143, an extension module 144, and a storage module 145.

The collection module 141 collects time-series structured data and common structured data. In this case, the time-series structured data is numerical data varying over time and may include the amount of rainfall, wind velocity, and the number of the floating population, for example. The time-series structured data varies over time, and thus the collection module 141 may collect time-series structured data at a specific time interval. The common structured data is numerical data that is not frequently changed and may include a building location and a road route, for example. The collection module 141 may check whether the common structured data has been changed in a predetermined specific cycle and may collect changed common structured data for an update when the common structured data is changed.

The collection module 141 may collect structured data from the disclosed databases (e.g., a weather DB, a disease-related DB, and a natural disaster DB) of society/public institutes (e.g., the National Weather Service and the Ministry of Health and Welfare).

The filter module 142 standardizes the time-series structured data and the common structured data. That is, the filter module 142 removes abnormal portions of the time-series structured data and the common structured data and standardizes various units and references. For example, if a specific value is abnormally high in the time-series structured data, the filter module 142 may remove the specific value.

The estimation module 143 corrects errors in the time-series structured data and common structured data standardized by the filter module 142 based on actually measured values on a spatiotemporal coordinate plane. That is, if the time-series structured data and common structured data standardized by the filter module 142 are not identical with previously defined standard coordinates, the estimation module 143 estimates values on the spatiotemporal coordinate plane with respect to mismatched data and corrects errors in the standardized time-series structured data and common structured data.

The extension module 144 extends the time-series structured data and common structured data whose errors have been corrected by the estimation module 143 to the data of all points on spatiotemporal coordinates. The time-series structured data and the common structured data are unable to provide all of pieces of information necessary for all locations and the entire time. Accordingly, the extension module 144 extends the time-series structured data and common structured data whose errors have been corrected to the data of all points on the spatiotemporal coordinates in order to associate the time-series structured data and common structured data with extraction knowledge candidates extracted from the unstructured data.

The storage module 145 distributes and stores in parallel the spatiotemporal association structured data extended spatiotemporally by the extension module 144.

Each of the unstructured data processing unit 110, the filter unit 120, and the structured data processing unit 140 may be implemented by a processor required to execute a program on a computing device. As described above, the unstructured data processing unit 110, the filter unit 120, and the structured data processing unit 140 may be implemented using physically independent elements and may be implemented in a form in which they are functionally divided within a single processor.

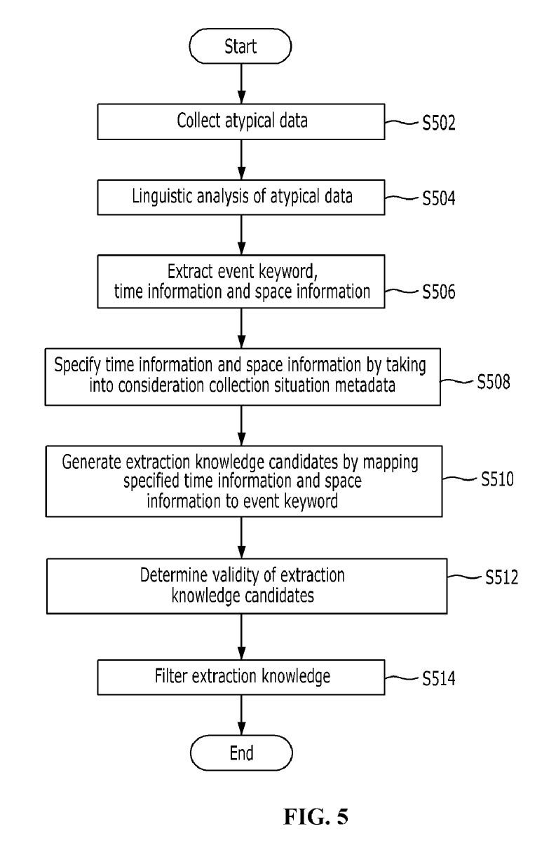

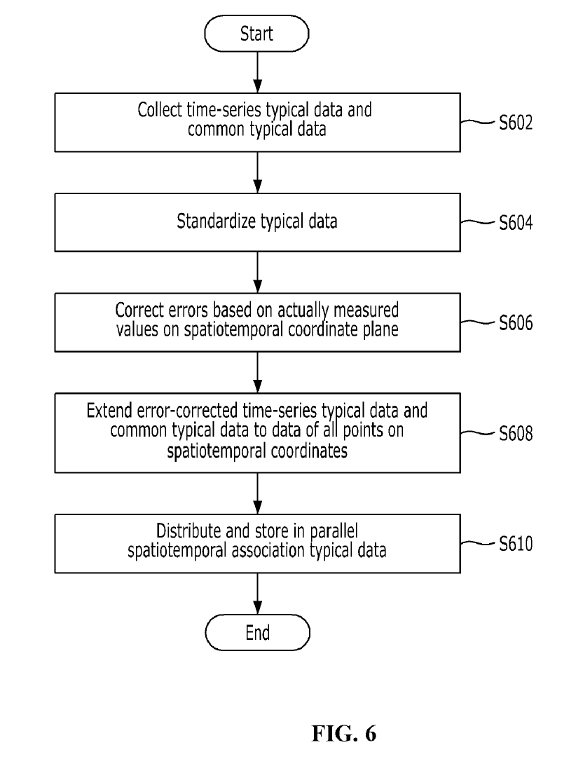

FIG. 5 is a flowchart illustrating a method for improving performance of unstructured text extraction according to an embodiment of the present invention.

Referring to FIG. 5, the system collects unstructured text and collection situation metadata from information sources at step S502.

The system performs a linguistic analysis of the collected unstructured data at step S504 and extracts time information or space information in which an event keyword and an event were generated at step S506. That is, the system performs a linguistic analysis of document data by performing a morphology analysis and NER and extracts the time information or space information in which the event keyword and the event were generated from the linguistically analyzed document data.

Thereafter, the system materializes the extracted time information or space information by taking into consideration collection situation metadata from which the unstructured data has been collected at step S508. That is, in order to solve the ambiguity of the time information extracted from the linguistically analyzed document data, the system converts the extracted time information into absolute time information using time meta-information included in the collection situation metadata. Furthermore, in order to solve the ambiguity of the space information extracted from the linguistically analyzed document data, the system materializes the extracted space information using space meta-information included in the collection situation metadata.

Thereafter, the system generates extraction knowledge candidates by mapping the materialized time information or space information to the event keyword at step S510.

Thereafter, the system determines the validity of the extraction knowledge candidates using spatiotemporal association structured data at step S512 and filters the extraction knowledge based on a result of the determination at step S514.

FIG. 6 is a flowchart illustrating a method for generating spatiotemporal association structured data according to an embodiment of the present invention.

Referring to FIG. 6, the system collects time-series structured data and common structured data at step S602. That is, the system collects the time-series structured data that is varied over time and the common structured data that is not frequently varied from a predetermined database.

The system standardizes the time-series structured data and the common structured data at step S604. If the standardized time-series structured data and the common structured data are not identical with previously defined standard coordinates, the system corrects errors based on actually measured values on a spatiotemporal coordinate plane at step S606.

The system extends the error-corrected time-series structured data and common structured data to the data of all points on the spatiotemporal coordinates at step S608 and distributes and stores in parallel the spatiotemporal association structured data that has been spatiotemporally extended at step S610.

Such a method for improving performance of unstructured text extraction may be written in a program form, and pieces of code and code segments forming the program may be easily reasoned by a programmer skilled in the art. Furthermore, a program regarding the method for improving performance of unstructured text extraction may be stored in information storage media (or information-readable media) and may be read and executed by an electronic device.

Technological characteristics described in this specification and an implementation for executing the technological characteristics may be implemented using a digital electronic circuit, may be implemented using computer software, firmware, or hardware including the structure described in this specification and structural equivalents thereof, or may be implemented using a combination of one or more of them. Furthermore, an implementation for executing the technological characteristics described in this specification may be implemented using a computer program product, that is, a module regarding computer program instructions encoded on a kind of program storage media in order to control the operation of a processing system or for execution by the processing system.

A computer-readable medium may be a machine-readable storage device, a machine-readable storage substrate, a memory device, a composition of materials that affect a machine-readable electromagnetic type signal or a combination of one or more of them.

Furthermore, the “computer-readable medium” described in this specification includes all media that contribute to the provision of instructions to a processor in order to execute a program. More specifically, the “computer-readable medium” includes nonvolatile memory, such as a data storage device, an optical disk, and a magnetic disk, volatile media, such as dynamic memory, and transmission media, such as a coaxial cable, a copper wire, and an optical fiber for transmitting data, but is not limited thereto.

In accordance with an embodiment of the present invention, the results of the extraction of text information can be verified using time information or space information indicative of an actual present situation.

Furthermore, improperly used text or social data can be removed, and only an event according to an actual situation can be extracted.

Advantages of the present invention are not limited to the aforementioned advantages and may include various other advantages within a range evident to those skilled in the art from the following description.

As described above, those skilled in the art to which the present invention pertains will appreciate that the present invention may be implemented in other detailed forms without changing the technical spirit or essential characteristic of the present invention. Furthermore, the illustrated flowcharts are merely order illustrated in implementing the present invention, and other additional steps may be provided or some of steps may be deleted.

Accordingly, it is to be understood that the aforementioned embodiments are only illustrative and do not have a limited range.

What is claimed is:

1. A system for improving performance of unstructured text extraction, comprising:
an unstructured data processing unit configured to extract time information or space information in which an event keyword and an event have been generated by performing a linguistic analysis on collected unstructured text and to generate extraction knowledge candidates by mapping the time information or space information to the event keyword; and
a filter unit configured to determine a validity of the extraction knowledge candidates generated by the unstructured data processing unit using spatiotemporal association structured data.

2. The system of claim 1, further comprising a structured data processing unit configured to collect structured data and generate spatiotemporal association structured data by standardizing the collected structured data.

3. The system of claim 2, wherein the structured data processing unit comprises:
a collection module configured to collect time-series structured data and common structured data;
a filter module configured to standardize the time-series structured data and the common structured data;
an estimation module configured to correct errors of the standardized time-series structured data and common structured data based on actually measured values on a spatiotemporal coordinate plane;
an extension module configured to extend the error-corrected time-series structured data and common structured data to data of all points on the spatiotemporal coordinates; and
a storage module configured to distribute and store in parallel the data extended by the extension module.

4. The system of claim 1, wherein the unstructured data processing unit comprises:
a collection module configured to collect the unstructured text from an information source;
an extraction module configured to extract the time information or space information in which the event keyword and the event have been generated by performing the linguistic analysis on the collected unstructured text;
an analysis module configured to materialize the extracted time information or space information; and
an association module configured to generate the extraction knowledge candidates by mapping the materialized time information or space information to the event keyword.

5. The system of claim 4, wherein if the collection module has collected collection situation metadata of the unstructured text, the analysis module comprises:
a time information analysis module configured to convert the extracted time information into absolute time information using time information included in the collection situation metadata; and
a space information analysis module configured to materialize the extracted space information using space information included in the collection situation metadata.

6. The system of claim 1, wherein the filter unit comprises a filter module configured to determine the validity of the extraction knowledge candidates using a precondition model suitable for the extraction knowledge candidates.

7. The system of claim 6, further comprising a condition model learning module configured to determine a precondition using the spatiotemporal association structured data and past history information.

8. A method for improving performance of unstructured text extraction, comprising steps of:
(A) collecting unstructured text;
(B) extracting time information or space information in which an event keyword and an event have been generated by performing a linguistic analysis on the collected unstructured text;
(C) generating extraction knowledge candidates by mapping the time information or space information to the event keyword; and
(D) determining a validity of the generated extraction knowledge candidates using spatiotemporal association structured data.

9. The method of claim 8, wherein if the unstructured text and collection situation metadata of the unstructured text have been collected in the step (A), the step (C) comprises:
converting the extracted time information into absolute time information using time information included in the collection situation metadata and materializing the extracted space information using space information included in the collection situation metadata; and
generating the extraction knowledge candidates by mapping the absolute time information or the materialized space information to the event keyword.

10. The method of claim 8, wherein the spatiotemporal association structured data is generated by standardizing time-series structured data and common structured data, correcting errors of the standardized time-series structured data and common structured data using actually measured values on a spatiotemporal coordinate plane, and extending the error-corrected time-series structured data and common structured data to data of all points on the spatiotemporal coordinates.

11. The method of claim 8, wherein the step (D) comprises:
selecting a precondition model for determining a validity of the extraction knowledge candidates in previously constructed precondition models; and
determining the validity of the extraction knowledge candidates using the selected precondition model and removing invalid extraction knowledge candidates.

12. The method of claim 11, wherein the precondition model is generated using a machine learning method using spatiotemporal association structured data and past history information.

13. A computer-readable recording medium on which a program for executing a method for improving performance of unstructured text extraction according to claim 8 has been recorded.

14. A computer-readable recording medium on which a program for executing a method for improving performance of unstructured text extraction according to claim 9 has been recorded.

15. A computer-readable recording medium on which a program for executing a method for improving performance of unstructured text extraction according to claim 10 has been recorded.

16. A computer-readable recording medium on which a program for executing a method for improving performance of unstructured text extraction according to claim 11 has been recorded.

17. A computer-readable recording medium on which a program for executing a method for improving performance of unstructured text extraction according to claim 12 has been recorded.
